(19) United States
(12) Patent Application Publication
(10) Pub. No.: US 2025/0267179 A1
(43) Pub. Date: Aug. 21, 2025

(54) COMPUTING SYSTEM PROVIDING PRESENTATION CONTENT SHARING FEATURES AND RELATED METHODS

(71) Applicant: UTOPIAN ADVENTURES LLC, MELBOURNE, FL (US)

(72) Inventors: THOMAS SVITAK, MELBOURNE, FL (US); MICHAEL KANE, MELBOURNE, FL (US); ROBERTO PANDO, PFLUGERVILLE, TX (US); BRITTANY SVITAK, MELBOURNE, FL (US)

(21) Appl. No.: 19/059,501

(22) Filed: Feb. 21, 2025

Related U.S. Application Data
(60) Provisional application No. 63/556,082, filed on Feb. 21, 2024.

(51) Int. Cl. H04L 65/403; H04L 12/18

(52) U.S. Cl. CPC H04L 65/403; H04L 12/1831

(57) ABSTRACT

A system may include at least one computer configured to display a presentation at a hosting location during a time window, at least one mobile device at the hosting location and configured to generate location data; and a cloud server. The cloud server may be configured to store the hosting location and the time window for the presentation in a presentation identification database. Responsive to the location data generated by the at least one mobile device at the hosting location, the cloud server may also identify the presentation being displayed by the at least one computer during the time window based upon the presentation identification database and the location data. The cloud server may further provide the at least one mobile device with access to supplemental data corresponding to the presentation upon identifying the presentation.

### TECHNICAL FIELD

The present disclosure generally relates to computing systems for facilitating presentations, and more particularly to computing platforms which provide for interactive content sharing during live or pre-recorded presentations and related methods.

### BACKGROUND

Various platforms exist for facilitating educational presentations by speakers. Such systems are generally feature-rich with respect to the front end presentation of the materials to the audience, e.g., in terms of the ability integrate different media, design templates, etc., that enhance the presentation experience. However, such systems may provide less than desired back end capabilities, e.g., in terms of audience interaction with the presentation materials and the ability of presenters to learn from such audience interaction.

As a result, further enhancements may be desirable for presentation platforms for various applications.

### SUMMARY

A system may include at least one computer configured to display a presentation at a hosting location during a time window, at least one mobile device at the hosting location and configured to generate location data, and a cloud server. The cloud server may be configured to store the hosting location and the time window for the presentation in a presentation identification database. Responsive to the location data generated by the at least one mobile device at the hosting location, the cloud server may also identify the presentation being displayed by the at least one computer during the time window based upon the presentation identification database and the location data. The cloud server may further provide the at least one mobile device with access to supplemental data corresponding to the presentation upon identifying the presentation.

In an example implementation, the at least one mobile device may be configured to generate the location data independent of the presentation. By way of example, the at least one mobile device may be configured to generate the location data based upon a QR code at the hosting location.

In some implementations, the at least one computer may comprise a plurality thereof configured to display respective presentations at different hosting locations during different time windows, and the cloud server may be configured to store the hosting locations and time windows for respective presentations in the presentation identification database. In an example implementation, the cloud server may be further configured to store subject matter points corresponding to different times during the presentation in the presentation identification database, and the supplemental data may comprise respective supplemental data for each of the subject matter points.

In one example implementation, the cloud server may be further configured to enable the at least one mobile device to access an interactive feature of the presentation responsive to identifying the presentation. Furthermore, the cloud server may be further configured to provide the at least one mobile device with access to the presentation responsive to identifying the presentation. By way of example, the supplemental data may include presenter notes, research materials for the presentation, etc.

A related method may include, at a cloud server, for a presentation to be displayed by at least one computer at a hosting location during a time window, storing the hosting location and the time window for the presentation at a cloud server in a presentation identification database. The method may further include, responsive to location data generated by at least one mobile device at the hosting location, identifying the presentation being displayed by the at least one computer during the time window based upon the presentation identification database and the location data, and providing the at least one mobile device with access to supplemental data corresponding to the presentation upon identifying the presentation.

A related non-transitory computer-readable medium is also provided having computer-executable instructions for causing a cloud server to perform steps including, for a presentation to be displayed by at least one computer at a hosting location during a time window, storing the hosting location and the time window for the presentation at a cloud server in a presentation identification database. The steps may further include, responsive to location data generated by at least one mobile device at the hosting location, identifying the presentation being displayed by the at least one computer during the time window based upon the presentation identification database and the location data, and providing the at least one mobile device with access to supplemental data corresponding to the presentation upon identifying the presentation.

### BRIEF DESCRIPTION OF THE DRAWINGS

FIG. 1 is a schematic flow diagram illustrating an example automated message creation process using a computing system in accordance with an example implementation.

FIG. 2 is a schematic flow diagram illustrating an example presentation interaction process using a computing system in accordance with an example implementation.

FIG. 3 is a schematic flow diagram illustrating an example automated reminder generation process using a computing system in accordance with an example implementation.

FIG. 4 is a schematic flow diagram illustrating an example automated content sharing process using a computing system in accordance with an example implementation.

FIG. 5 is a screen shot of an example graphical user interface (GUI) providing audience interaction capabilities with a computing system in accordance with an example implementation.

FIG. 6 is a screen shot of an example GUI providing presenter interaction capabilities with a computing system in accordance with an example implementation.

FIG. 7 is a screen shot of the GUI of FIG. 6 providing automated presenter reporting features in accordance with an example implementation.

FIG. 8 is a schematic block diagram of a presentation system in accordance with an example implementation.

FIG. 9 is a flow diagram illustrating method aspects associated with the system of FIG. 8.

FIG. 10 is a screen shot illustrating an example interactive challenge feature which may be implemented by the system of FIG. 8.

### DETAILED DESCRIPTION

Example implementations will now be described more fully hereinafter with reference to the accompanying drawings, in which the example implementations are shown. The example may, however, be implemented in many different forms and should not be construed as limited to the specific configurations set forth herein. Rather, these implementations are provided so that this disclosure will be thorough and complete.

Generally speaking, the present disclosure is directed to a computing system to enhance the learning experience of audiences during live or pre-recorded presentations. More specifically, a method and system are provided that allow presenters to use a unique data structure to digitally share the main points of their presentation. In an example implementation, presenters may utilize Quick-Response (QR) codes or anchor links associated with particular points within their presentations, or QR codes identifying the hosting location of the presentation, enabling audience members to access supplementary information, research materials, and facilitate topic sharing.

Some implementations may include having video of the original presentation available at the QR code or anchor link's destination. If configured to do so, when audience members later return to the destination the video may be set to begin playing at the precise moment the QR code was displayed in the original presentation.

The system may also allow presenters to see how audience members interact with their message during and after their presentation. The platform may further provide presenters with advanced insights into the main points of their presentations that had the greatest amount of interactions and personalizations. Also, audience members may retain meaningful presentations and interact with them on-demand as needed.

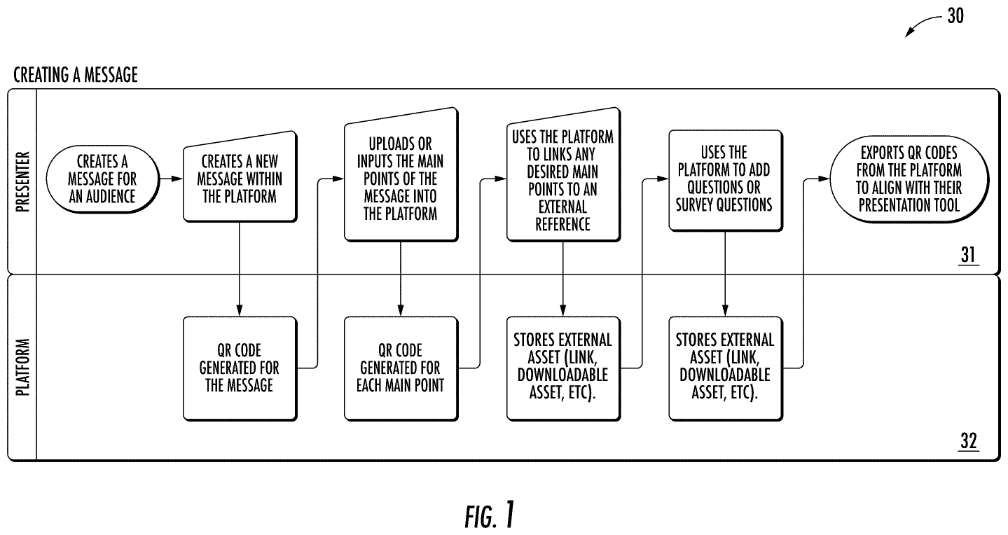

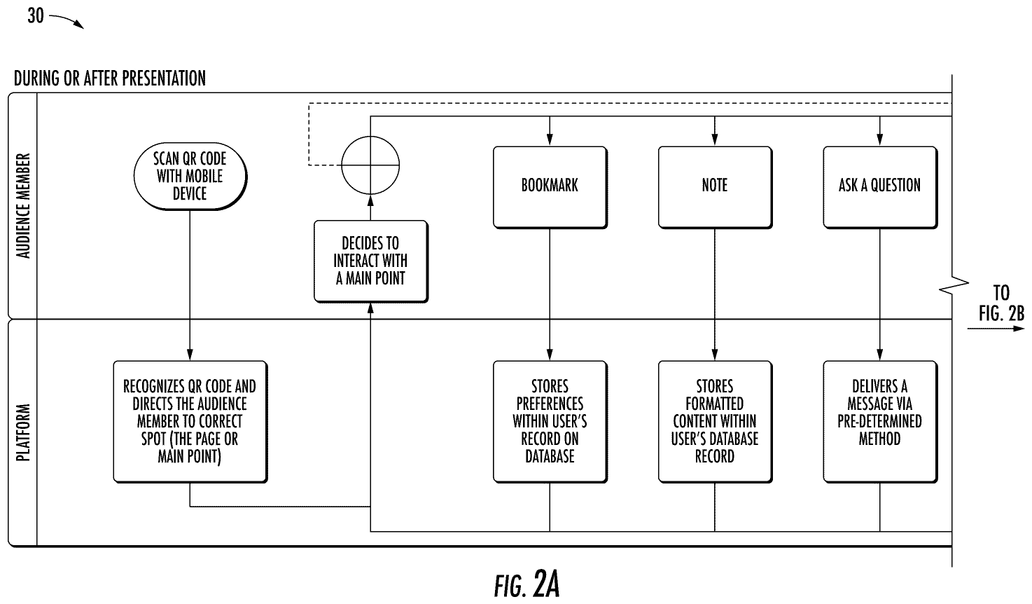

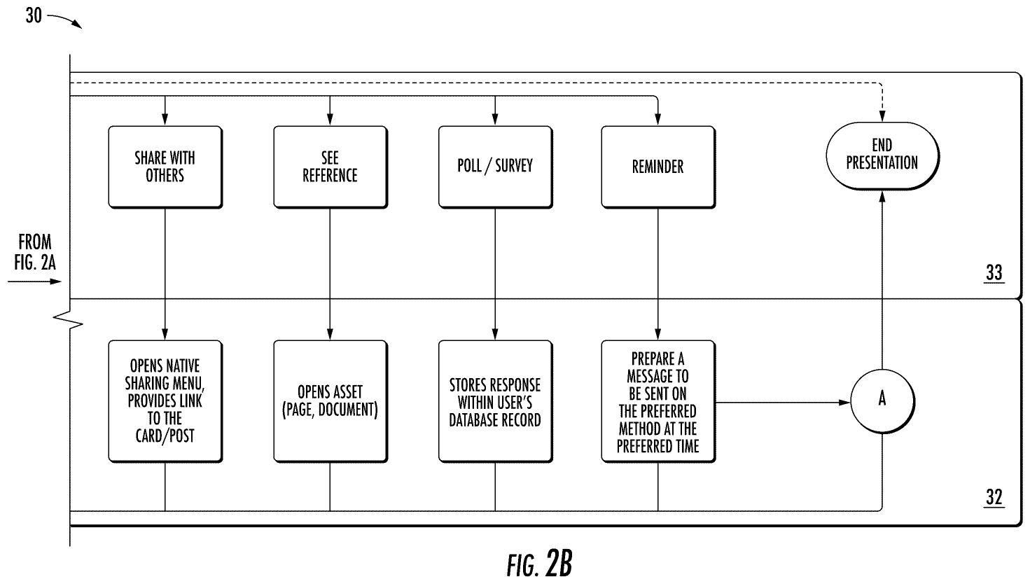

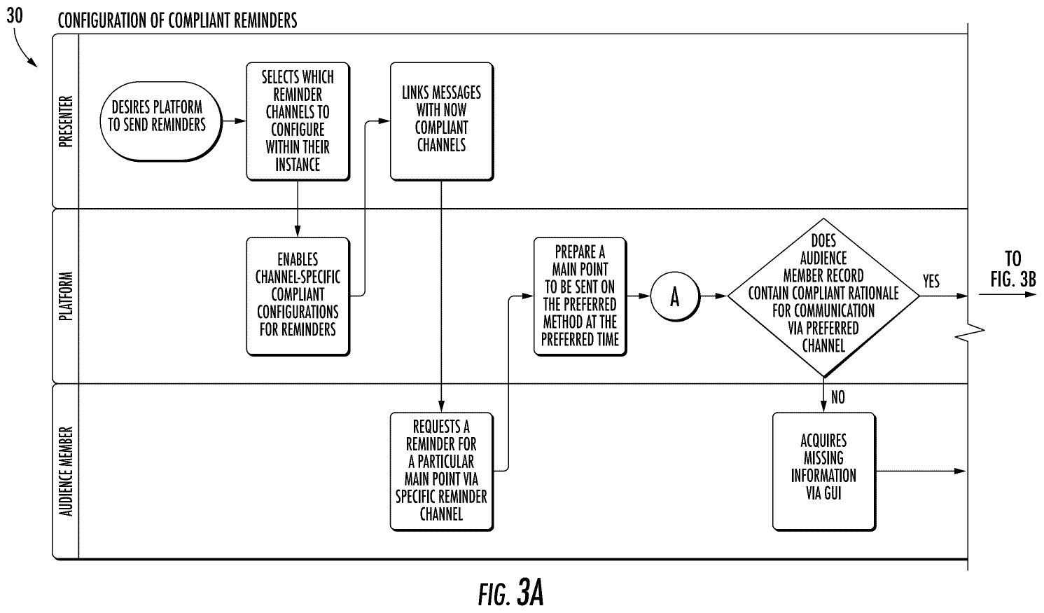

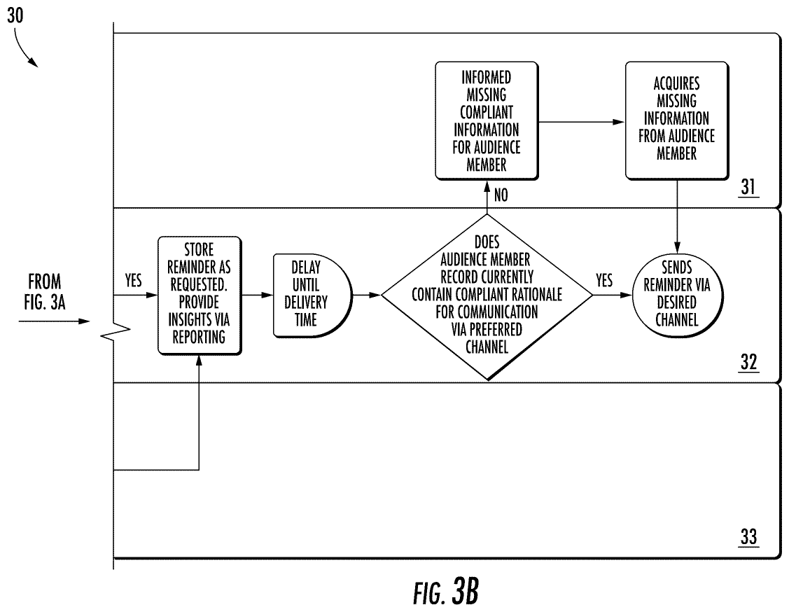

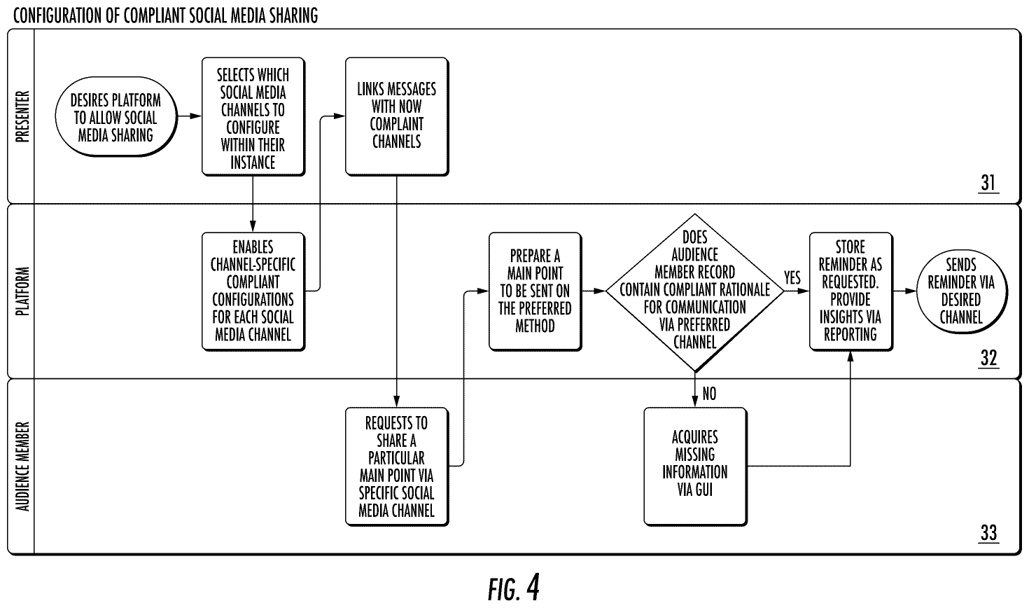

Turning now to FIGS. 1-5, a computing system 30 and its operation are now described. The system 30 may advantageously be used for live and pre-recorded presentations, providing participants with the ability to interact via a graphical user interface (GUI) 50 with different portions of the presentation to facilitate automated information exchange and reporting. The computing system 30 may be implemented using appropriate hardware (e.g., a processor and associated components) and software embodied in a non-transitory computer-readable. In some implementations, the computing system 30 may be implemented across one or more computers, including presenter computers 31 (e.g., PCs, Macs, laptops, tablets, etc.) and platform computer(s) 32 (e.g., servers) which may be local (on-premises) or remote, such as in a cloud-computing configuration, for example.

The software may be configured to cause the computing system 30 to automatically create, manage, and share a presentation and particular main points within a presentation via QR codes generated by the platform computer 32. Furthermore, the system 30 may allow presenters to catalog their presentations. For example, presenters may use the platform computer 32 to generate QR codes and anchor links for the presentation and/or main points within the presentation, and the system 30 may report how individual audience members interact with the presentation.

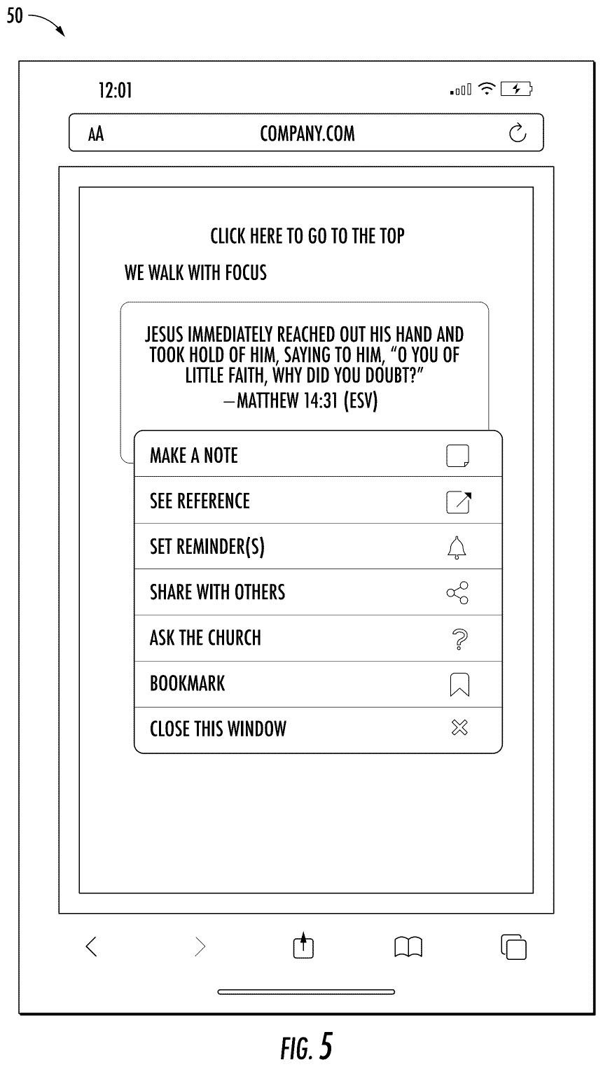

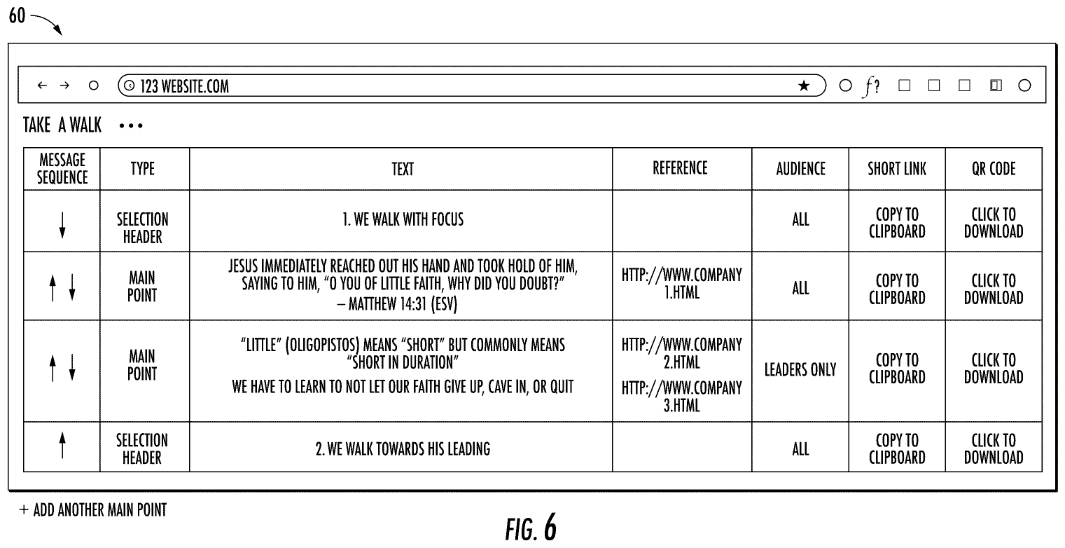

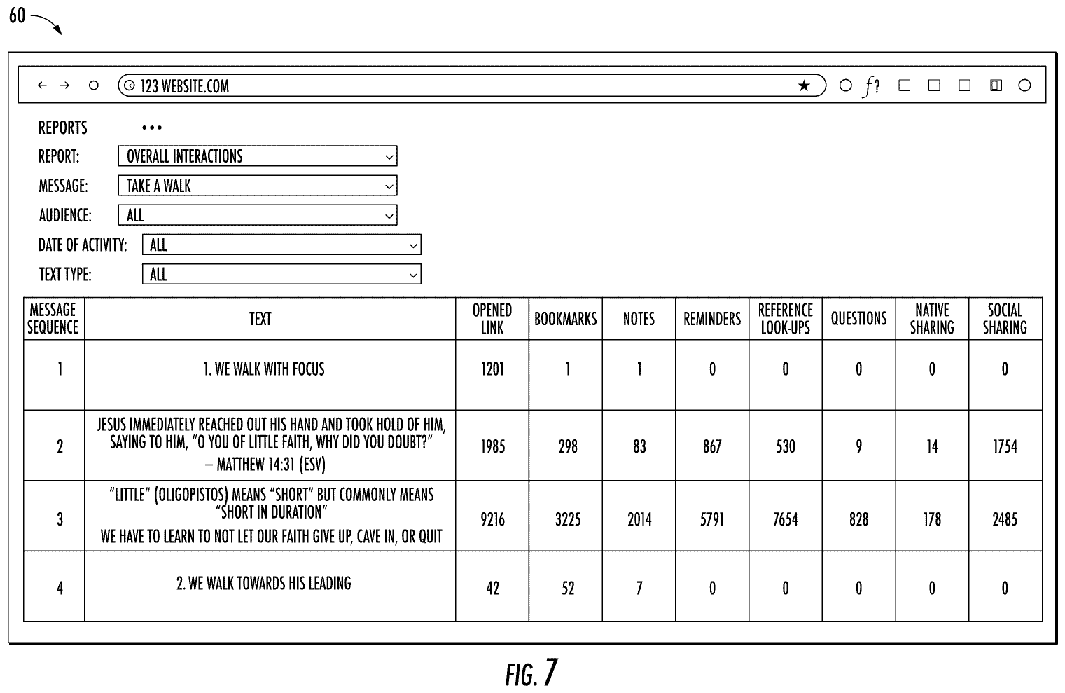

Referring additionally to FIGS. 6-7, the system advantageously provides an intuitive user interface (GUI) 60 for presenters to input, upload, organize, and edit content for each main point within a presentation. The platform computer 32 may be configured so that presenters can add supplemental assets to support their main points, which in turn can be accessed by audience members through a hyperlink or downloading the asset, for example. Audience members may also interact with the presentation on their own mobile devices 31 (e.g., smart phones, tablets, etc.) with respective user interfaces, which will be discussed further below.

The system 30 may also provide for unique anchor link and/or QR code generation. Presenters may upload, paste, or type their presentation into the platform computer 32 via the graphical user interface. The platform computer 32 provides an interface for presenters to generate an anchor link and/or QR codes for their presentation. These QR codes may be unique to each main point and may also be easily downloadable, printable, and shareable. The presenter may also designate which main points are publicly available, or if there is some type of privacy or filtering they prefer.

Audience members or attendees may scan the QR codes with their smartphones or other QR code-scanning mobile devices 33. Upon scanning, their device 33 opens their device's browser (or to a screen within a native app in some implementations) to the website configured by the presenter (which may be hosted by the platform computer 32 or elsewhere). From the site, audience members may see the presentation, gain access to the corresponding information, including presenter notes, research materials, and any additional content provided by the presenter. Depending on the presenter's configurations of the presentation, the platform computer 32 may require the audience member to complete a validation/identification process to gain the corresponding access to any parts filtered by the presenter. Before allowing there to be privacy or filtering, the presenter may first configure the platform computer 32 to determine the validity of individual audience members' identities.

Beyond verifying an audience member's identity, there are other instances where audience member data may be stored. Audience members may personalize their experience by interacting with the presentation or main points within the presentation. Those personalizations may also be saved by the platform computer 32 so that the platform computer can both correctly display them again and report on them to the presenter.

The platform compute 32 may also allow audience members to personalize each presentation. Audience members may perform one or more of the following example actions for designated points of a presentation:
a) Natively take personal notes immediately in-line with the main point of a presentation. Some configurations may allow the audience member to begin conversations with other audience members, as well as adjust the privacy settings of their notes so others can see what they wrote as notes.
b) Bookmark a main point, allowing users to easily navigate back to items they have bookmarked. Some configurations may allow audience members to adjust the privacy settings of their bookmarks so others can see what they bookmarked.
c) Share a link to a particular main point within the presentation with their peers by using the device's native sharing tools (discussed further below).
d) Ask a question to the presenter using the presenter's preferred way to receive questions from audience members.
e) Set personal reminders regarding the main point, which may be saved within the platform computer 32 and then delivered via the platform computer at the time the audience member chooses. The presenter may configure the platform computer 32 to send reminders via various channels and then allow the audience members to choose their preferred channels. Some implementations might include channels such as native/internal platform notifications, SMS, MMS, email, or social media platforms. Reminders may be delivered to the audience member in a manner compliant with existing regulatory constraints of the channel (discussed further below).

Some presenters may video record their presentation. Upon uploading the presentation video, any platform generated QR codes associated with the main points may be observed and stored by the platform computer 32. This requires a unique data structure. More particularly, because each main point has a distinct QR code, the unique anchor link URL from the QR code loads the page already scrolled to the appropriate spot for the main point. The unique anchor link URL also loads the video to the precise moment the QR code is displayed by the presenter while discussing the main point. This prevents audience members and the people they refer to the presentation's page to bypass points that might be less relevant to them. These data points may be extremely valuable to the presenter, and the platform's reporting may indicate which points are more or less meaningful.

In an example implementation, a special purpose database table may be created that will effectively store one row per main point. The main point row includes the timestamp of the video, but the timestamp is entered after the QR Code is already generated. The QR Code ultimately tells the page which main point to scroll down to. Then, if a video is available at the configured hosting location and a timestamp is known, the system fast forwards the video to that point in time. To understand how to display the video, a different special purpose table (or tables) are generated which point to which hosting service to grab the video from, as well as the hosting service's particular values and parameters to input to embed the video on the page. The URL tells the page which main point row to look for and to perform the aforementioned functions.

The system 30 may further provide management of reminder channel compliance in some implementations. Audience members wanting a reminder of a main point may want to receive that reminder outside of the native user interface of the platform. Instead, they may want the platform to deliver that reminder via their preferred channel such as SMS, MMS, email, or a social media inbox.

Each distinct channel has its own regulatory and compliance requirements that need to be adhered to. The platform computer 32 may assist the presenter to both become compliant when starting their use of the platform and remain compliant in the event changes occur. For example, if an audience member no longer wants to receive SMS updates and wants to “Opt-out” by replying to a text message, the platform will assist the presenter configure their instance of the platform with the required “stop” messages. Similarly, email requires users to have a webpage to be able to modify their subscription settings. The platform computer 32 may store the user's preferences to ensure it only delivers compliant emails. Further, each social media network likely has its own governance with platform integrations. The platform computer 32 may be configured to automatically abide by each governing authority's individualized compliance requirements.

In some implementations, a URL-shortener feature may be provided. More particularly, the platform computer 32 may allow the presenter to generate a redirecting URL to the presentation page as well as to each main point's unique anchor link URL. To allow the shared link to easily fit within the limitations of a single SMS message, some implementations of the tool create shortened links. Those short links redirect to the appropriate location, but use less characters.

In particular, the shortened link may cause the platform computer 32 to return to the precise moment of the video and associated location in the scrolling notes. When an audience member uses a link or returns to the page determined by the QR code or anchor link, the audience member returns to the page already scrolled to the corresponding main point. If the presenter has already uploaded a video of the presentation displaying the platform-generated QR codes, then the platform computer 32 will use a unique data structure to determine the precise moment that QR code appeared on the screen the video allowing the audience member to begin watching the video at that moment in time with no need to fast forward.

With regard to sharing capabilities, audience members may easily share main points to other recipients using their mobile device's native sharing tool set and the channels connected with their mobile device 33. In doing so, the platform computer 32 sends the other channel the anchor link to the particular main point the audience member is sharing. When the recipients click on the anchor link they are taken to the main point and as discussed before, the video might be available and loaded to the particular moment. When permitted by the social media channel, social media channels might play the video clip determined by the platform. These shared anchor links might be used by the presenter to have threaded conversations about the main point with individuals other than just their audience members. The platform computer 32 will use a unique data structure to differentiate platform interactions by audience members and non-audience members.

In an example implementation, the platform computer 32 will know the precise moment an activity occurs. So, if an interaction occurs after the time of the presentation, the activity occurred by a non-audience member. Additionally, if the device allows, the platform computer 32 will track the physical location of the activity. When the mobile device 33 does not allow the platform to know the precise physical location, the platform computer 32 will look up their IP address. The reporting may then be filtered by the platform computer 32 to give the presenter more insights by audience segment. In FIG. 7, an example filter “drop list” labeled “Audience” is shown for selecting such segmentation.

As noted above, the system 30 also provides for reporting to the presenter on personalizations made by the audience members. The platform computer 32 may be configured to provide reporting, statistics, and feedback to presenters on the way audience members and other recipients interact with their presentations and the main points of the presentation(s). Presenters may desire to know what main points receive the most interactions. Reports may be automatically generated to provide insights into the utilization of the various features such as Notes, Bookmarks, Questions, Reference lookups, and Reminders. Presenters might also desire to know which main points and presentations get shared the most, and how many recipients of that shared presentation further interact with the presentation via the platform.

The platform computer 32 may use a unique data structure to aggregate the personalizations and interactions from many presentations the presenter has created. Using machine learning, the platform computer 32 can provide insights to the presenter by finding the commonality between main points that have the greatest amounts of personalization and interactions. Conversely, they can learn which main points have the lowest rate of personalization or interactions, which likely bring the least value to the audience member. In an example implementation, a combination of reinforcement learning, contextual bandits, K-means, hierarchical clustering, and/or text classification algorithms may be used by the platform to intake how audience members perform personalization (e.g., through bookmarks, notes, and questions asked) to know future messages and main points presenters can share on. Further, the platform may use similar strategies to recommend additional references, e.g., for a later spot, since it is the audience member. Machine learning may also be implemented to benefit audience members by suggesting reminder dates and times, and posting to one or many social platforms or known groups within the platform itself.

The above-described computing system 30 may provide numerous advantages. For example, the system 30 may enhance the learning experience for audience members during and after presentations, encourage engagement and interaction with educational content, and facilitate the sharing of knowledge and collaborative learning.

To summarize, the present application provides a computing platform for creating, managing, and sharing QR codes associated with educational presentations. QR codes or other suitable indicators may be generated for each main point in a presentation, linking to supplementary information, teacher notes, research materials, and additional resources. An interface may be provided for presenters to input, organize, and edit content for each main point, including teacher notes, research materials, and additional resources.

The system 30 also allows audience members to scan the QR codes of interest, gaining access to the corresponding information and enabling them to take notes, set reminders, and highlight important information. The platform computer 32 may also allow users to share main points, notes, and associated materials with their peers, as well as allow presenters to see how their audience members interact with their messages, as discussed further above.

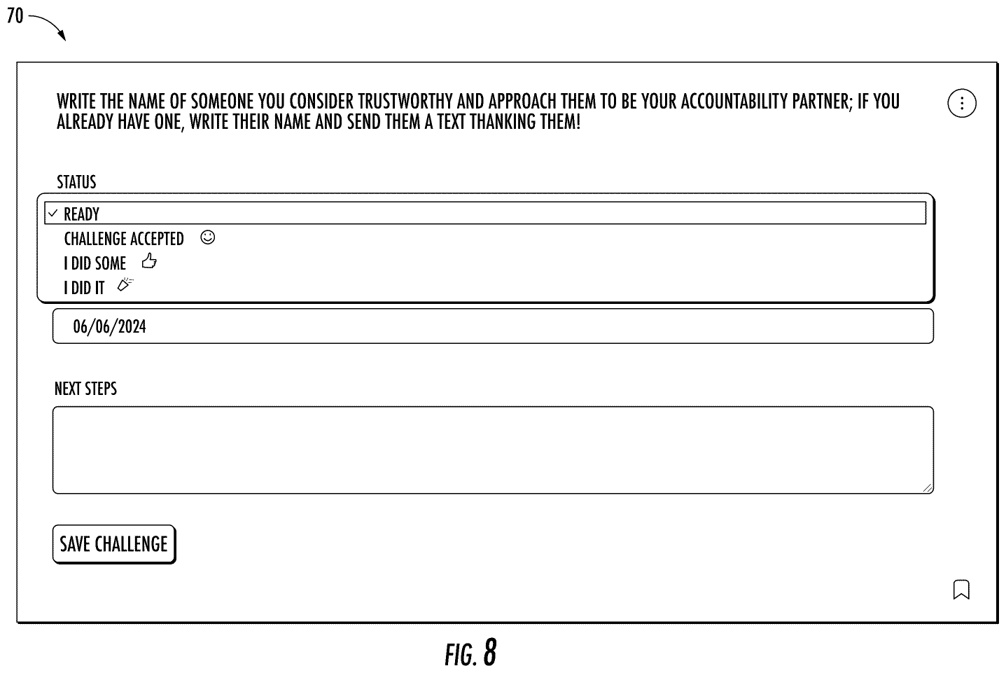

Referring additionally to the screen shot 70 of FIG. 8, in accordance with another example aspect the system 30 may enable a presenter to add an element to user GUI 50 suggesting some type of practical application relevant to the topic or point at hand. The audience member can then be reminded to implement the suggested application from the presenter, and track their adherence to the suggested application. In the illustrated example, this is a challenge to an accountability partner, but the challenge or reminder may be about other points as well. Additionally, the audience member could choose his or her own implementation. For example, the user may choose to self-propagate the application, or leverage artificial intelligence (AI) or machine learning (ML) that the presenter has integrated with the platform. The presenter can also see this data, which allows them to know how to modify or keep information from future presentations.

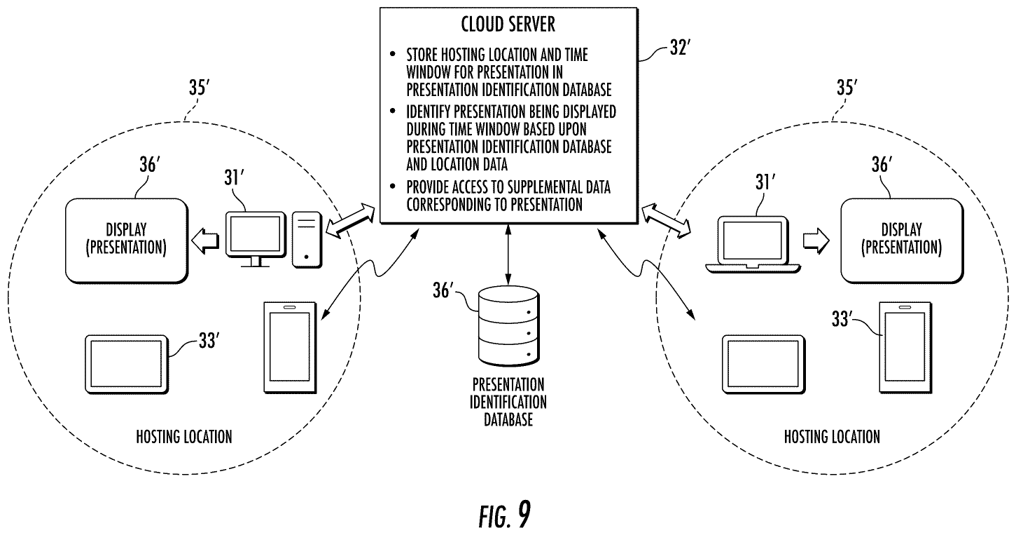

Turning now to FIG. 9, in another example implementation the system 30′ may utilize location data generated from an attendee's mobile device (e.g., smart phone, tablet, etc.) to identify the respective hosting location 35′ where the mobile device 33′ is located, and from this information the associated presentation that the user of the mobile device is attending. The presenter or presentation computer 31′ is configured to display a presentation (here on respective displays 36′) at the hosting location 35′ during respective time windows. For example, the presenter may schedule or register a time when the presentation is to start and stop (or start and duration) at the given location (or multiple locations in some embodiments). A presenter may also run the presentation from the platform computer 32′ (here a cloud server), from which the cloud computer will automatically know the time window when the presentation starts and stops.

As such, when a mobile device 33′ at a hosting location 35′ scans a QR code associated with the hosting location (e.g., a QR code on a chair seatback where the user is sitting), this will prompt the mobile device 33′ to contact the cloud server 32′ with location indication data obtained from the QR code. In another example implementation, the mobile device may be running an app associated with the platform which, when prompted by the user, sends location information (e.g., GPS data, wireless network address, etc.) to the cloud computer 33′. This may be accompanied by a time stamp from the mobile device 33′ as well, or the time may be determined by the cloud computer 32′ in some implementations.

As discussed further above, the presenter may register the presentation with the cloud server 32′ using the interface 60, for example. The cloud server 32′ may store the hosting location and the time window for the presentation in a presentation identification database 36′, for example. As such, responsive to receiving the location data generated by the mobile device while at the hosting location, the cloud server 32′ may thereby identify the presentation being displayed by the presentation computer 31′ during the time window based upon the presentation identification database and the location data from the mobile device. The cloud server 32′ may further provide the mobile device 33′ with access to supplemental data corresponding to the presentation, access to the presentation (whether live or recorded), etc., as discussed further above. In particular, the time stamp may be used to identify particular subject points the user is interested in, as opposed to embedded QR codes or links in the presentation at different times as discussed above.

In this example implementation, the mobile device generates the location data independent of the presentation. That is, here the QR code, GPS data, etc., identifies the hosting location itself, not the presentation or a specific point within the presentation as discussed above. This configuration may be advantageous in that a hosting location may have many different presentations given there, and in the present implementation the system 30′ allows these different presentation all to be identified without having to generate respective QR codes for each (or different points therein). The cloud server 32′ on the backend determines what the presentation is and what point the user desires more information about based upon the location data and time stamp occurring within the known time window for the presentation.

As seen in the present example, the cloud server 32′ may interface with multiple different presentation computers 31′ and mobile devices 33′ across many different hosting locations 35′. Moreover, in some embodiments the same presentation computer 31 could be used to display the same presentation at multiple different locations (e.g., in the case of a church with a central location and satellite locations). In such cases, the database 36′ may be further configured to associate a same presentation with different locations, and provide different supplemental information and/or different interaction options to mobile devices 33′ at different locations accordingly, if desired.

The same functionality discussed above with respect to supplemental data for different subject matter points (e.g., presenter notes, research materials, etc.), interactivity features, access to the presentation feed (live and/or recorded), etc., may similarly be provided by the cloud server 32′ in the system 30′.

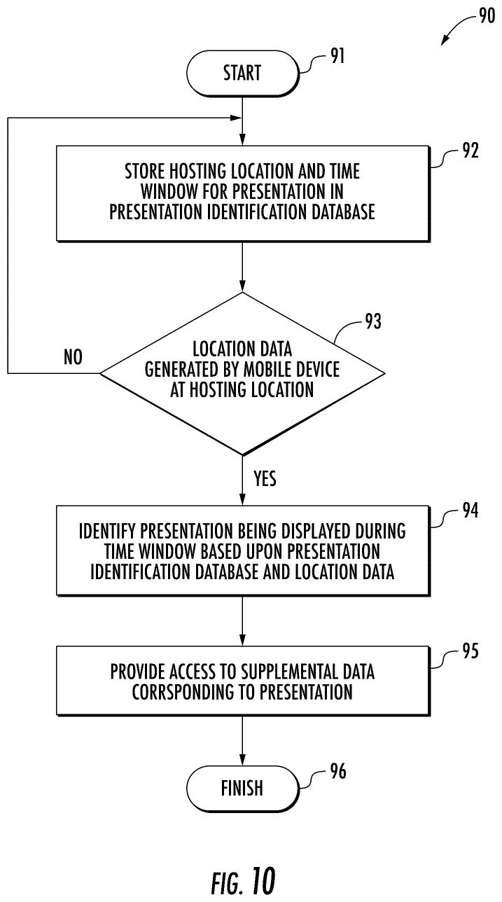

Turning to the flow diagram 90 of FIG. 10, related method aspects are now described. Beginning at Block 91, the method begins (Block 91) with storing the hosting location 35′ and the time window for the presentation in the presentation identification database 36′, at Block 92. The method further illustratively includes, responsive to the location data generated by one of the mobile devices 33′ at the hosting location 35′, identifying the presentation being displayed by the presenter computer 31′ during the time window based upon the presentation identification database 36′ and the location data (Blocks 93-94), and providing the mobile device with access to supplemental data corresponding to the presentation upon identifying the presentation (Block 95), as discussed further above. The method of FIG. 10 illustratively concludes at Block 96. A related non-transitory computer-readable medium may also be implemented in the cloud server 32′ also provided having computer-executable instructions for causing the cloud server to perform the steps illustrated in FIG. 10.

Many modifications and other implementations of the invention will come to the mind of one skilled in the art having the benefit of the teachings presented in the foregoing descriptions and the associated drawings. Therefore, it is understood that the invention is not to be limited to the specific implementations disclosed, and that other modifications and implementations are intended to be included within the scope of this disclosure.

1. A system comprising:
at least one computer configured to display a presentation at a hosting location during a time window;
at least one mobile device at the hosting location and configured to generate location data; and
a cloud server configured to
store the hosting location and the time window for the presentation in a presentation identification database,
responsive to the location data generated by the at least one mobile device at the hosting location, identify the presentation being displayed by the at least one computer during the time window based upon the presentation identification database and the location data, and
provide the at least one mobile device with access to supplemental data corresponding to the presentation upon identifying the presentation.

2. The system of claim 1 wherein the at least one mobile device is configured to generate the location data independent of the presentation.

3. The system of claim 2 wherein the at least one mobile device is configured to generate the location data based upon a QR code at the hosting location.

4. The system of claim 1 wherein the at least one computer comprises a plurality thereof configured to display respective presentations at different hosting locations during different time windows, and wherein the cloud server is configured to store the hosting locations and time windows for respective presentations in the presentation identification database.

5. The system of claim 1 wherein the cloud server is further configured to store subject matter points corresponding to different times during the presentation in the presentation identification database, and wherein the supplemental data comprises respective supplemental data for each of the subject matter points.

6. The system of claim 1 wherein the cloud server is further configured to enable the at least one mobile device to access an interactive feature of the presentation responsive to identifying the presentation.

7. The system of claim 1 wherein the cloud server is further configured to provide the at least one mobile device with access to the presentation responsive to identifying the presentation.

8. The system of claim 1 wherein the supplemental data includes one or more of presenter notes and research materials for the presentation.

9. A method comprising:
at a cloud server,
for a presentation to be displayed by at least one computer at a hosting location during a time window, storing the hosting location and the time window for the presentation in a presentation identification database;
responsive to location data generated by at least one mobile device at the hosting location, identifying the presentation being displayed by the at least one computer during the time window based upon the presentation identification database and the location data; and
providing the at least one mobile device with access to supplemental data corresponding to the presentation upon identifying the presentation.

10. The method of claim 9 wherein the at least one mobile device is configured to generate the location data independent of the presentation.

11. The method of claim 10 wherein the at least one mobile device is configured to generate the location data based upon a QR code at the hosting location.

12. The method of claim 9 wherein the at least one computer comprises a plurality thereof configured to display respective presentations at different hosting locations during different time windows; and further comprising, at the cloud server, storing the hosting locations and time windows for respective presentations in the presentation identification database.

13. The method of claim 9 further comprising, at the cloud server, storing subject matter points corresponding to different times during the presentation in the presentation identification database, and wherein the supplemental data comprises respective supplemental data for each of the subject matter points.

14. The method of claim 9 further comprising, at the cloud server, enabling the at least one mobile device to access an interactive feature of the presentation responsive to identifying the presentation.

15. A non-transitory computer-readable medium having computer-executable instructions for causing a cloud server to perform steps comprising:
for a presentation to be displayed by at least one computer at a hosting location during a time window, storing the hosting location and the time window for the presentation in a presentation identification database;
responsive to location data generated by at least one mobile device at the hosting location, identifying the presentation being displayed by the at least one computer during the time window based upon the presentation identification database and the location data; and
providing the at least one mobile device with access to supplemental data corresponding to the presentation upon identifying the presentation.

16. The non-transitory computer-readable medium of claim 15 wherein the at least one mobile device is configured to generate the location data independent of the presentation.

17. The non-transitory computer-readable medium of claim 16 wherein the at least one mobile device is configured to generate the location data based upon a QR code at the hosting location.

18. The non-transitory computer-readable medium of claim 15 wherein the at least one computer comprises a plurality thereof configured to display respective presentations at different hosting locations during different time windows; and further having computer-executable instructions for causing the cloud server to store the hosting locations and time windows for respective presentations in the presentation identification database.

19. The non-transitory computer-readable medium of claim 15 further having computer-executable instructions for causing the cloud server to store subject matter points corresponding to different times during the presentation in the presentation identification database, and wherein the supplemental data comprises respective supplemental data for each of the subject matter points.

20. The non-transitory computer-readable medium of claim 15 further having computer-executable instructions for causing the cloud server to enable the at least one mobile device to access an interactive feature of the presentation responsive to identifying the presentation.
